(19) United States
(12) Patent Application Publication
(10) Pub. No.: US 2025/0167967 A1
(43) Pub. Date: May 22, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 18/841,149

(22) PCT Filed: Feb. 10, 2023
(86) PCT No.: PCT/JP2023/004631

§ 371 Date: Aug. 23, 2024

(30) Foreign Application Priority Data
Feb. 24, 2022 (JP) 2022-026886

(51) Int. Cl. H04L 5/00; H04W 72/232

(52) U.S. Cl. CPC H04L 5/0091; H04W 72/232

(57) ABSTRACT

A terminal according to an aspect of the present disclosure includes: a receiving section that receives a list indicating transmission configuration indication (TCI) states applicable to a plurality of types of signals and a configuration related to a field in downlink control information for indication of one or more TCI states in the list; and a control section that determines a size of the field on the basis of at least one of the list, the configuration, and capability information related to the indication. An aspect of the present disclosure allows a TCI state to be appropriately recognized.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied that a user terminal (terminal, User Equipment (UE)) controls transmission/reception processing, based on information related to quasi-co-location (QCL) (QCL assumption/Transmission Configuration Indication (TCI) state/spatial relation).

It is also studied that a TCI state applicable to a plurality of types of signals (channels/reference signals) is indicated by downlink control information. However, a method of such indication is not clear. Unless such a method is clear, degradation in communication quality, throughput reduction, and the like may be caused.

In view of this, an object of the present disclosure is to provide a terminal, a radio communication method, and a base station that appropriately determine a TCI state.

### Solution to Problem

A terminal according to an aspect of the present disclosure includes: a receiving section that receives a list indicating transmission configuration indication (TCI) states applicable to a plurality of types of signals and a configuration related to a field in downlink control information for indication of one or more TCI states in the list; and a control section that determines a size of the field on the basis of at least one of the list, the configuration, and capability information related to the indication.

### Advantageous Effects of Invention

An aspect of the present disclosure allows a TCI state to be appropriately recognized.

### BRIEF DESCRIPTION OF DRAWINGS

FIGS. 1A and 1B are each a diagram to show an example of a unified/common TCI framework.

FIG. 2 shows, in Aspect 1-1, an example of a method of determining whether a TCI field in DCI format 1_1 is present.

FIG. 3 shows, in Aspect 1-1, an example of a method of determining whether a TCI field in DCI format 1_2 is present.

FIG. 4 shows, in Aspect 1-2, an example of a method of determining whether a TCI field in DCI format 1_1 is present.

FIG. 5 shows, in Aspect 1-2, an example of a method of determining whether a TCI field in DCI format 1_2 is present.

FIG. 6 shows, in a variation of Aspect 1-2, an example of a method of determining whether a TCI field in DCI format 1_1 is present.

FIG. 7 shows, in a variation of Aspect 1-2, an example of a method of determining whether a TCI field in DCI format 1_2 is present.

FIG. 8 shows an example of joint DL/UL TCI state indication.

FIG. 9 shows an example of separate DL/UL TCI state indication.

FIG. 10 is a diagram to show an example of a schematic structure of a radio communication system according to one embodiment.

FIG. 11 is a diagram to show an example of a structure of a base station according to one embodiment.

FIG. 12 is a diagram to show an example of a structure of a user terminal according to one embodiment.

FIG. 13 is a diagram to show an example of a hardware structure of the base station and the user terminal according to one embodiment.

FIG. 14 is a diagram to show an example of a vehicle according to one embodiment.

### DESCRIPTION OF EMBODIMENTS

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE, based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a given signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have a different parameter(s) (or a parameter set(s)) that can be assumed to be the same, and such parameters (which may be referred to as QCL parameters) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a given control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a given channel/signal, and this RS may be referred to as a QCL source of QCL type X in the TCI state.

### (Unified/Common TCI Framework)

With a unified TCI framework, UL and DL channels can be controlled by a common framework. A unified TCI framework may indicate a common beam (common TCI state) and apply the common beam to all the UL and DL channels instead of defining a TCI state or a spatial relation for each channel as in Rel. 15, or apply a common beam for UL to all the UL channels while applying a common beam for DL to all the DL channels.

One common beam for both DL and UL or a common beam for DL and a common beam for UL (two common beams in total) are studied.

The UE may assume the same TCI state (joint TCI state, joint TCI pool, joint common TCI pool, joint TCI state set) for UL and DL. The UE may assume respective different TCI states (separate TCI states, separate TCI pools, UL separate TCI pool and DL separate TCI pool, separate common TCI pools, UL common TCI pool and DL common TCI pool) for UL and DL.

By beam management based on a MAC CE (MAC CE level beam indication), default UL and DL beams may be aligned. A default TCI state of a PDSCH may be updated to match to a default UL beam (spatial relation).

By beam management based on DCI (DCI level beam indication), a common beam/unified TCI state may be indicated from the same TCI pool (joint common TCI pool, joint TCI pool, set) for both UL and DL. X (>1) TCI states may be activated by a MAC CE. UL/DL DCI may select one from the X active TCI states. The selected TCI state may be applied to channels/RSs of both UL and DL.

The TCI pool (set) may be a plurality of TCI states configured by an RRC parameter or a plurality of TCI states (active TCI states, active TCI pool, set) activated by a MAC CE among the plurality of TCI states configured by the RRC parameter. Each TCI state may be a QCL type A/D RS. As the QCL type A/D RS, an SSB, a CSI-RS, or an SRS may be configured.

The number of TCI states corresponding to each of one or more TRPs may be defined. For example, the number N (≥1) of TCI states (UL TCI states) to be applied to a UL channel/RS and the number M (≥1) of TCI states (DL TCI states) to be applied to a DL channel/RS may be defined. At least one of N and M may be notified/configured/indicated, for a UE, through higher layer signaling/physical layer signaling.

In the present disclosure, in a case of describing N=M=X (X is any integer), this may mean that X TCI states (corresponding to X TRPs) common to UL and DL (joint TCI states) are notified/configured/indicated for a UE. In a case of describing N=X (X is any integer) and M=Y (Y is any integer and Y may be X (Y=X)), this may mean that X UL TCI states (corresponding to X TRPs) and Y DL TCI states (corresponding to Y TRPs) (i.e., separate TCI states) are notified/configured/indicated for a UE.

For example, in a case of describing N=M=1, this may mean that one TCI state that corresponds to a single TRP and that is common to UL and DL is notified/configured/indicated for a UE (a joint TCI state for a single TRP).

For example, in a case of describing N=1 and M=1, this may mean that one UL TCI state and one DL TCI state that correspond to a single TRP are separately notified/configured/indicated for a UE (separate TCI states for a single TRP).

For example, in a case of describing N=M=2, this may mean that a plurality of (two) TCI states that correspond to a plurality of (two) TRPs and that are common to UL and DL are notified/configured/indicated for a UE (joint TCI states for a plurality of TRPs).

For example, in a case of describing N=2 and M=2, this may mean that a plurality of (two) UL TCI states and a plurality of (two) DL TCI states that correspond to a plurality of (two) TRPs are notified/configured/indicated for a UE (separate TCI states for a plurality of TRPs).

Note that, although a case is described that the value of each of N and M is 1 or 2 in the example described above, the value of each of N and M may be 3 or more and N may be different from M.

For Rel. 17, it is studied that N=M=1 is supported. For Rel. 18 or later versions, it is studied that another case is supported.

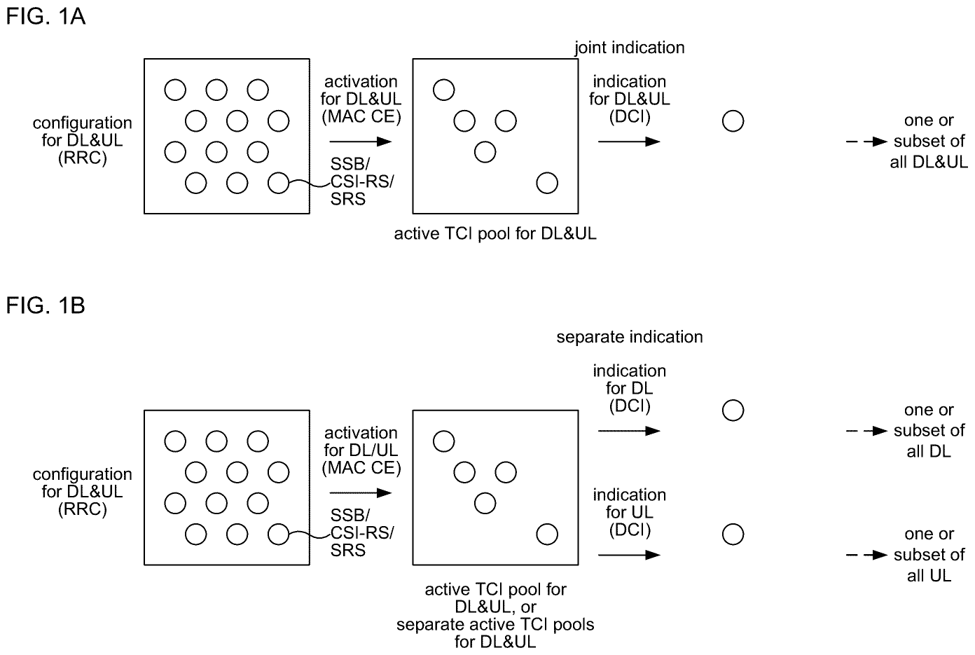

In an example in FIG. 1A, an RRC parameter (information element) configures a plurality of TCI states for both DL and UL. The MAC CE may activate a plurality of TCI states among the plurality of configured TCI states. DCI may indicate one of the plurality of activated TCI states. The DCI may be UL/DL DCI. The indicated TCI state may be applied to at least one (or all) of UL/DL channels/RSs. One piece of DCI may indicate both a UL TCI and a DL TCI.

In the example in FIG. 1A, one dot may represent one TCI state applied to both UL and DL or may represent two respective TCI states applied to UL and DL.

At least one of the plurality of TCI states configured by the RRC parameter and the plurality of TCI states activated by the MAC CE may be referred to as a TCI pool (common TCI pool, joint TCI pool, TCI state pool). The plurality of TCI states activated by the MAC CE may be referred to as an active TCI pool (active common TCI pool).

Note that, in the present disclosure, a higher layer parameter (RRC parameter) that configures a plurality of TCI states may be referred to as configuration information that configures a plurality of TCI states or simply as “configuration information.” In the present disclosure, one of a plurality of TCI states being indicated by using DCI may be receiving indication information indicating one of a plurality of TCI states included in DCI or may simply be receiving “indication information.”

In an example in FIG. 1B, an RRC parameter configures a plurality of TCI states for both DL and UL (joint common TCI pool). A MAC CE may activate a plurality of TCI states (active TCI pool) among the plurality of configured TCI states. Respective (different, separate) active TCI pools for UL and DL may be configured/activated.

DL DCI or a new DCI format may select (indicate) one or more (for example, one) TCI states. The selected TCI state(s) may be applied to one or more (or all) DL channels/RSs. The DL channel(s) may be a PDCCH/PDSCH/CSI-RS(s). The UE may determine the TCI state of each of the DL channels/RSs by using operation of a TCI state (TCI framework) of Rel. 16. UL DCI or a new DCI format may select (indicate) one or more (for example, one) TCI states. The selected TCI state(s) may be applied to one or more (or all) UL channels/RSs. The UL channel(s) may be a PUSCH/SRS/PUCCH(s). Thus, different pieces of DCI may indicate a UL TCI and a DL DCI separately.

Beam indication DCI for a unified/common TCI state may be DCI format 1_1/1_2 with DL assignment (scheduling).

Beam indication DCI for a unified/common TCI state may be DCI format 1_1/1_2 without DL assignment (scheduling) or may be a new DCI format. This is beneficial when there is no DL data but beam indication for the unified/common TCI state.

### (TCI State Indication)

A Rel-17 unified TCI framework supports Mode 1 to Mode 3 below.
{Mode 1}MAC CE based TCI state indication
{Mode 2}DCI based TCI state indication with DL assignment (DCI based TCI state indication by DCI format 1_1/1_2 with DL assignment)
{Mode 3}DCI based TCI state indication without DL assignment (DCI based TCI state indication by DCI format 1_1/1_2 without DL assignment)

A UE with a TCI state configured and activated with a Rel-17 TCI state ID (for example, tci-StateId_r17) receives, for one CC, DCI format 1_1/1_2 providing an indicated TCI state with a Rel-17 TCI state ID or receives, for all CCs in a CC list the same as a CC list configured by simultaneous TCI update list 1 or simultaneous TCI update list 2 (for example, simultaneousTCI-UpdateList1 or simultaneousTCI-UpdateList2), DCI format 1_1/1_2 providing an indicated TCI state with a Rel-17 TCI state ID. DCI format 1_1/1_2 may be with DL assignment if available or may be without DL assignment.

If DCI format 1_1/1_2 is without DL assignment, a UE may assume (verify) the following for the DCI.
A CS-RNTI is used in CRC scramble for the DCI
Values of the following DCI fields (special fields) are set as below:
   A redundancy version (RV) field is set to all ‘1’s
   A modulation and coding scheme (MCS) field is set to all ‘1’s
   A new data indicator (NDI) field is set to 0
   A frequency domain resource assignment (FDRA) field is set to all ‘0’s for FDRA type 0, or set to all ‘1’s for FDRA type 1, or set to all ‘0’s (similarly to DL semi-persistent scheduling (SPS) or validation of a PDCCH of release of UL grant type 2 scheduling) for dynamic switch (DynamicSwitch)

In Rel. 15/16, if a UE does not support active BWP change through DCI, the UE ignores a BWP indicator field. A similar operation is also under study regarding relation between support of a Rel-17 TCI state and understanding of a TCI field. It is under study that a TCI field is always present in DCI format 1_1/1_2 if a UE is configured with a Rel-17 TCI state. It is under study that a UE ignores a TCI field if the UE does not support TCI update through DCI.

In Rel. 15/16, whether a TCI field is present (TCI presence in DCI information, tci-PresentInDCI) is configured per CORESET.

A TCI field in DCI format 1_1 has 0 bits in a case where a higher layer parameter tci-PresentInDCI is not enabled, otherwise 3 bits. If a BWP indicator field indicates a BWP other than an active BWP, a UE follows an operation below.

{Operation} If the higher layer parameter tci-PresentInDCI is not enabled for a CORESET to be used for a PDCCH communicating such DCI format 1_1, the UE assumes that tci-PresentInDCI is enabled for none of CORESETs in the indicated BWP, otherwise the UE assumes that tci-PresentInDCI is enabled for all the CORESETs in the indicated BWP.

A TCI field in DCI format 1_2 has 0 bits in a case where a higher layer parameter tci-PresentInDCI-1-2 is not configured, otherwise 1, 2, or 3 bits determined by the higher layer parameter tci-PresentInDCI-1-2. If a BWP indicator field indicates a BWP other than an active BWP, a UE follows an operation below. {Operation} If the higher layer parameter tci-PresentInDCI-1-2 is not configured for a CORESET to be used for a PDCCH communicating such DCI format 1_2, the UE assumes that tci-PresentInDCI is enabled for none of CORESETs in the indicated BWP, otherwise the UE assumes that tci-PresentInDCI-1-2, with a value the same as that of tci-PresentInDCI-1-2 configured for the CORESET to be used for the PDCCH communicating such DCI format 1_2, is configured for all the CORESETs in the indicated BWP.

However, a method of indication of a Rel-17 TCI state based on DCI is not clear. Unless such a method is clear, indication of a TCI state may not be appropriately performed, causing throughput reduction/degradation in communication quality.

In view of this, the inventors of the present invention came up with the idea of a method of indication of a TCI state.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an RRC information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a Rel-17 TCI state, an indicated Rel-17 TCI state (a Rel-17 TCI state to be indicated, a TCI state to be indicated), a shared TCI state, a common beam, common TCI, a common TCI state, a TCI state in Rel. 17 or later versions, unified TCI, a unified TCI state, a TCI state to be applied to signals (channels/RSs) of a plurality of types, a TCI state to be applied to a plurality of (plurality of types of) signals (channels/RSs), a TCI state applicable to a plurality of types of signals (channels/RSs), a TCI state for a plurality of types of signals, a TCI state for signals (channels/RSs) of a plurality of types, a TCI state, a unified TCI state, a TCI state for DL and UL for joint TCI indication (joint DL/UL TCI state), a separate TCI state for DL/UL (separate DL/UL TCI state), a UL only TCI state for separate TCI indication, a DL only TCI state for separate TCI indication, a joint TCI state for DL and UL, and a separate TCI state for each of DL and UL may be interchangeably interpreted.

In the present disclosure, a Rel-15/16 TCI state, a TCI state/spatial relation to be applied only to a specific channel/RS, and a TCI state/spatial relation to be applied to a channel/RS of one type may be interchangeably interpreted.

In the present disclosure, a plurality of TCI states configured by an RRC IE, a plurality of TCI states activated by a MAC CE, information related to one or more TCI states, a TCI state configuration, a TCI state pool, an active TCI state pool, a common TCI state pool, a unified TCI state pool, a list, a TCI state list, a unified TCI state list, a joint TCI state pool, a separate TCI state pool, a separate DL/UL TCI state pool, a DL TCI state pool, a UL TCI state pool, a separate DL TCI state pool, and a separate UL TCI state pool may be interchangeably interpreted.

In the present disclosure, DL TCI, DL only TCI, separate DL only TCI, DL common TCI, DL unified TCI, common TCI, and unified TCI may be interchangeably interpreted. In the present disclosure, UL TCI, UL only TCI, separate UL only TCI, UL common TCI, UL unified TCI, common TCI, and unified TCI may be interchangeably interpreted.

In the present disclosure, a channel/RS to which a unified TCI state is applied may be a PDSCH/PDCCH/CSI-RS/PUSCH/PUCCH/SRS.

In the present disclosure, UE-individual reception on a PDSCH/PDCCH, reception of a PDSCH/PDCCH based on a PDSCH configuration (PDSCH-Config)/PDCCH configuration (PDCCH-Config), a UE-individual PDSCH/PDCCH, and a resource for a UE-individual PDSCH/PDCCH may be interchangeably interpreted. In the present disclosure, a PUSCH based on a dynamic grant/configured grant, a PUSCH based on a PUSCH configuration (PUSCH-Config)/configured grant configuration (ConfiguredGrantConfig), a UE-individual PUSCH, and a UE-individual PUSCH resource may be interchangeably interpreted. In the present disclosure, an individual PUCCH resource, a PUCCH resource based on a PUCCH configuration (PUCCH-Config), a UE-individual PUCCH, and a UE-individual PUCCH resource may be interchangeably interpreted.

### (Radio Communication Method)

In the embodiments, an RRC IE for configuration of a TCI field for indication of a Rel-17 TCI state, an RRC IE indicating that a TCI field for indication of a Rel-17 TCI state is present in DCI, an RRC IE indicating a size of a TCI field for indication of a Rel-17 TCI state, TCI presence in DCI information, tci-PresentInDCI, tci-PresentInDCI-1-2, tci-PresentInDCI_r17, and tci-PresentInDCI-1-2 r17 may be interchangeably interpreted.

### First Embodiment

This embodiment relates to a method of configuration of a TCI field for a Rel-17 TCI state (at least one of joint DL/UL TCI, DL only TCI, and UL only TCI).

### <<Aspect 1-1>>

A TCI field for a Rel-17 TCI state may be configured by a common RRC parameter (tci-PresentInDCI) with that for configuration of a TCI field for a Rel-15/16 TCI state.

In a given band, only either one of a Rel-15/16 TCI state/spatial relation or a Rel-17 TCI state may be able to be configured.

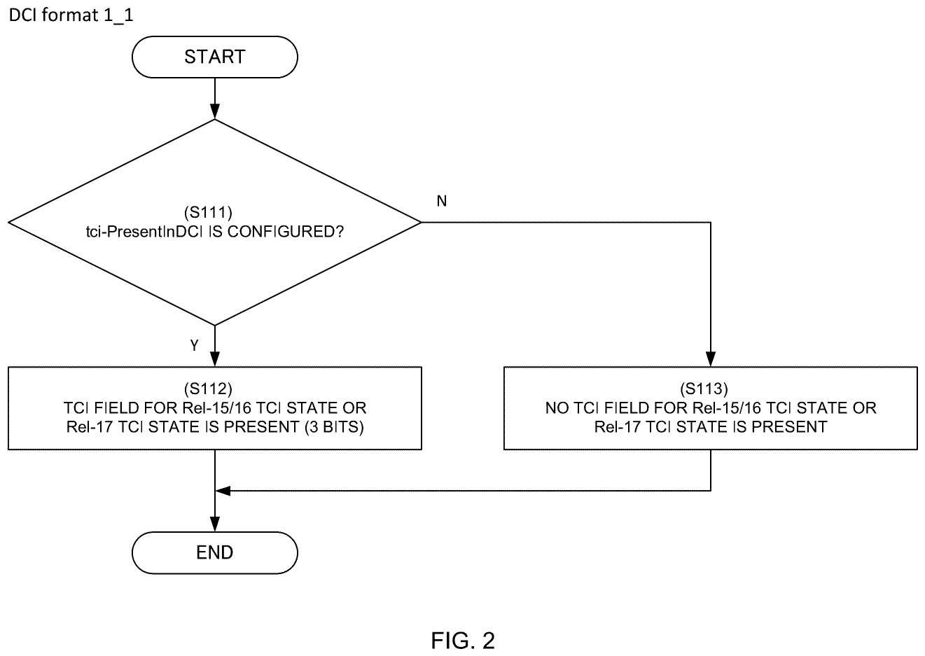

FIG. 2 shows, in Aspect 1-1, an example of a method of determining whether a TCI field in DCI format 1_1 is present. In S111, a UE judges whether tci-PresentInDCI is configured. If tci-PresentInDCI is configured (S111: Y), in S112, the UE judges that a TCI field for a Rel-15/16 TCI state or a Rel-17 TCI state is present. Such a TCI field may have a size of 3 bits. Otherwise (S111: N), in S113, the UE judges that no TCI field for a Rel-15/16 TCI state or a Rel-17 TCI state is present.

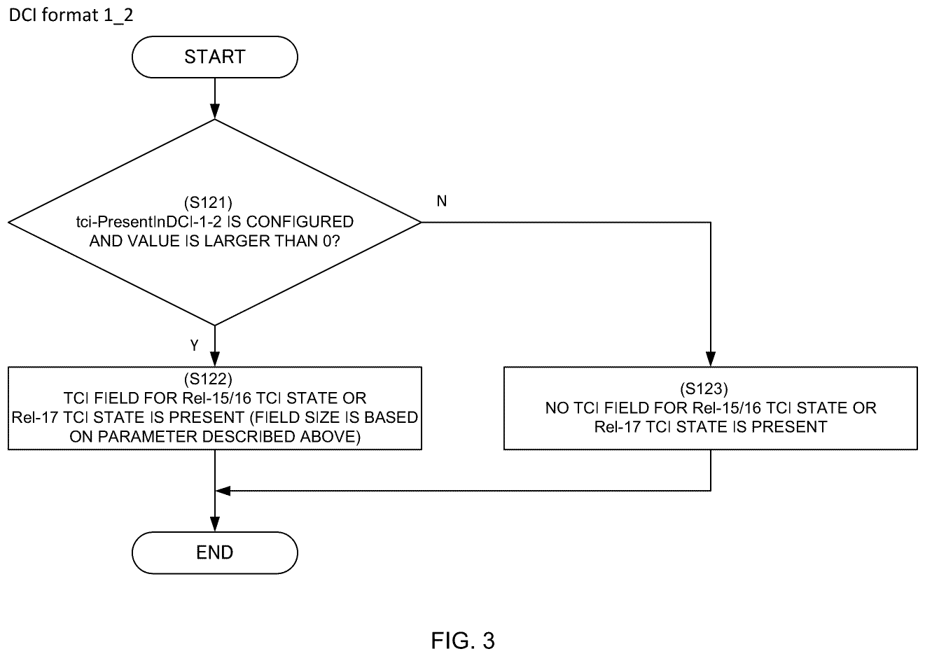

FIG. 3 shows, in Aspect 1-1, an example of a method of determining whether a TCI field in DCI format 1_2 is present. In S121, a UE judges whether tci-PresentInDCI-1-2 is configured and the value is larger than 0. If tci-PresentInDCI-1-2 is configured and the value is larger than 0 (S121: Y), in S122, the UE judges that a TCI field for a Rel-15/16 TCI state or a Rel-17 TCI state is present. Such a TCI field may have a size based on the value of tci-PresentInDCI-1-2. Otherwise (S121: N), in S123, the UE judges that no TCI field for a Rel-15/16 TCI state or a Rel-17 TCI state is present.

A Rel-17 TCI state indicated by DCI of a given CORESET may be applied to another CORESET. In this case, it is not preferable that a Rel-17 TCI state is configured per CORESET.

### Example

In a case where a Rel-17 TCI state is configured, at least one of a configuration of whether tci-PresentInDCI is enabled and a configuration of the value of tci-PresentInDCI-1-2 may be the same over all CORESETs.

Such constriction may be applied per CC/per band/per UE. Such constriction may be applied in a case where DCI based TCI indication is configured. Having configured DCI based TCI indication may mean that a plurality of active TCI states are configured per CC/per band/per UE.

### Modification Examples

In a case where a Rel-17 TCI state is configured, at least one of a configuration of whether tci-PresentInDCI is enabled and a configuration of the value of tci-PresentInDCI-1-2 may depend on a CORESET (may not need to be the same over every CORESET). The number of bits/DCI size of a TCI field in DCI format 1_1 may be determined based on a configuration further increasing the number of bits (size) of the TCI field in DCI format 1_1, out of configurations for CORESETs. The number of bits/DCI size of a TCI field in DCI format 1_2 may be determined based on a configuration further increasing the number of bits (size) of the TCI field in DCI format 1_2, out of configurations for CORESETs.

For example, in a case that, for CORESET #1, tci-PresentInDCI is enabled and tci-PresentInDCI-1-2=2 bits is configured and that, for CORESET #2, tci-PresentInDCI is not enabled and tci-PresentInDCI-1-2=1 bit is configured, a TCI field (3 bits) may be present in DCI format 1_1 and a TCI field in DCI format 1_2 may have 2 bits, in all the CORESETs.

Such constriction may be applied per CC/per band/per UE. Such constriction may be applied in a case where DCI based TCI indication is configured. Having configured DCI based TCI indication may mean that a plurality of active TCI states are configured per CC/per band/per UE.

The DCI size may be common to all the CORESETs. Regardless of whether tci-PresentInDCI is enabled and a configuration of tci-PresentInDCI-1-2 for each of the CORESETs, the TCI fields of the respective CORESETs may be the same in size. The size of a TCI field to be actually indicated (the number of bits to be used for an actual indication) may depend on whether tci-PresentInDCI is enabled and a configuration of tci-PresentInDCI-1-2 for each of the CORESETs. For example, in a CORESET configured with TCI field size=1 bit by tci-PresentInDCI-1-2, when a 2-bit TCI field common to all the CORESETs is configured, a UE may assume that a TCI state is indicated by 1 bit (MSB or LSB) of the 2-bit TCI field and ignore the rest of the bits in the TCI field.

### <<Aspect 1-2>>

A TCI field for a Rel-17 TCI state may be configured by an RRC parameter different from that for configuration of a TCI field for a Rel-15/16 TCI state.

A new parameter for configuration of a TCI field for a Rel-17 TCI state may be configured per CORESET/per BWP/per CC/per band/per CC group. Such a new parameter may be a parameter per DCI format (for example, TCI presence in DCI information for Rel. 17, tci-PresentInDCI_r17, tci-PresentInDCI-1-2_r17).

A Rel-17 TCI state indicated by DCI of a given CORESET may be applied to another CORESET. In this case, it is not preferable that a Rel-17 TCI state is configured per CORESET.

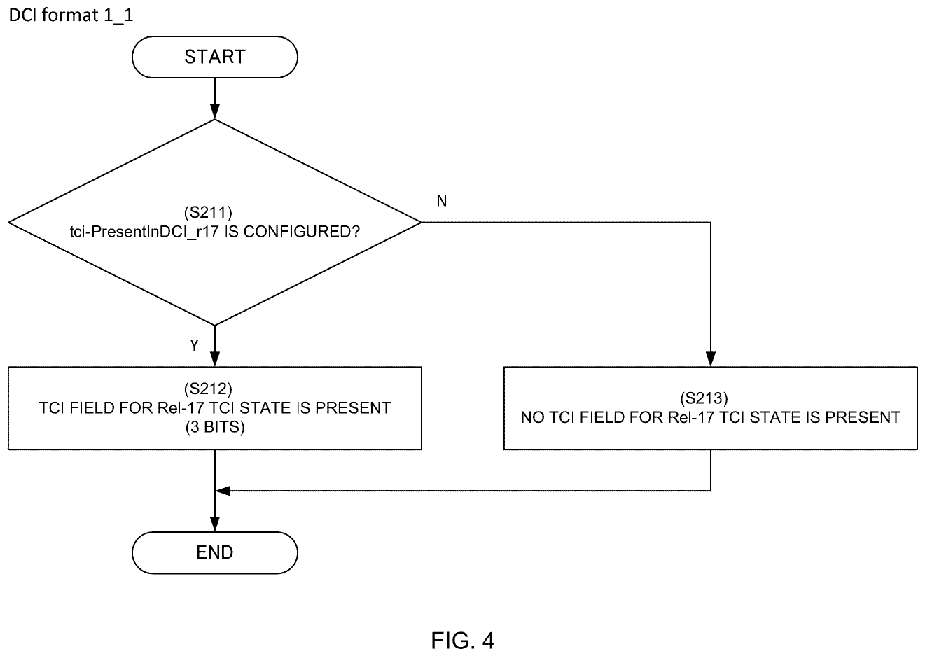

FIG. 4 shows, in Aspect 1-2, an example of a method of determining whether a TCI field in DCI format 1_1 is present. In S211, a UE judges whether tci-PresentInDCI_r17 is configured. If tci-PresentInDCI_r17 is configured (S211: Y), in S212, the UE judges that a TCI field for a Rel-17 TCI state is present. Such a TCI field may have a size of 3 bits. Otherwise (S211: N), in S213, the UE judges that no TCI field for a Rel-17 TCI state is present.

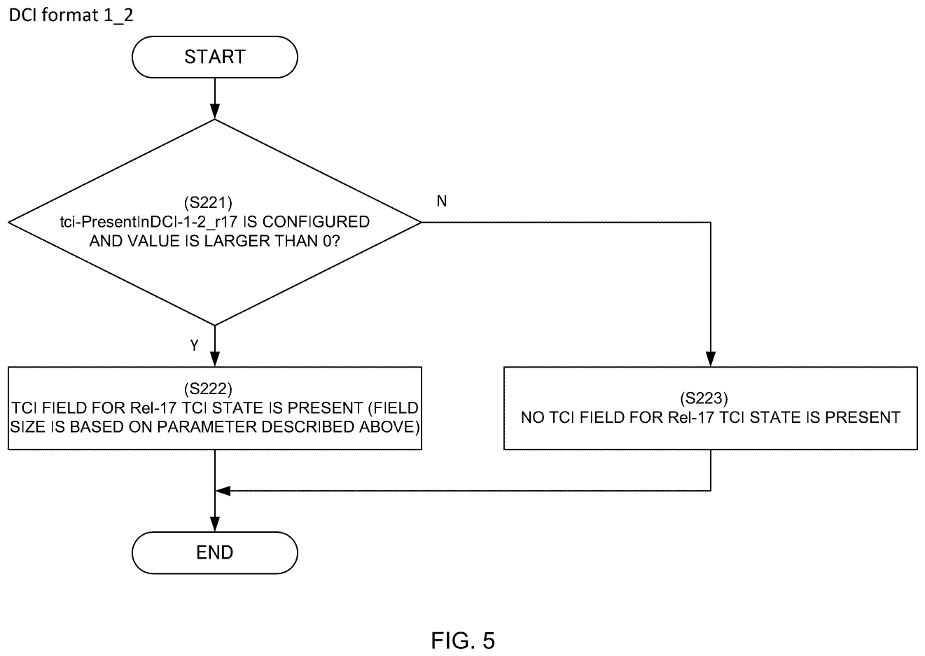

FIG. 5 shows, in Aspect 1-2, an example of a method of determining whether a TCI field in DCI format 1_2 is present. In S221, a UE judges whether tci-PresentInDCI-1-2_r17 is configured and the value is larger than 0. If tci-PresentInDCI-1-2 r17 is configured and the value is larger than 0 (S221: Y), in S222, the UE judges that a TCI field for a Rel-17 TCI state is present. Such a TCI field may have a size based on the value of tci-PresentInDCI-1-2 r17. Otherwise (S221: N), in S223, the UE judges that no TCI field for a Rel-17 TCI state is present.

### <<Variations of Aspect 1-2>>

A TCI field for a Rel-17 TCI state may be configured by an RRC parameter different from that for configuration of a TCI field for a Rel-15/16 TCI state.

A new parameter for configuration of a TCI field for a Rel-17 TCI state may be configured per CORESET/per BWP/per CC/per band/per CC group. Such a new parameter may be common to DCI format 1_1/1_2 (for example, TCI presence in DCI information for Rel. 17, tci-PresentInDCI_r17).

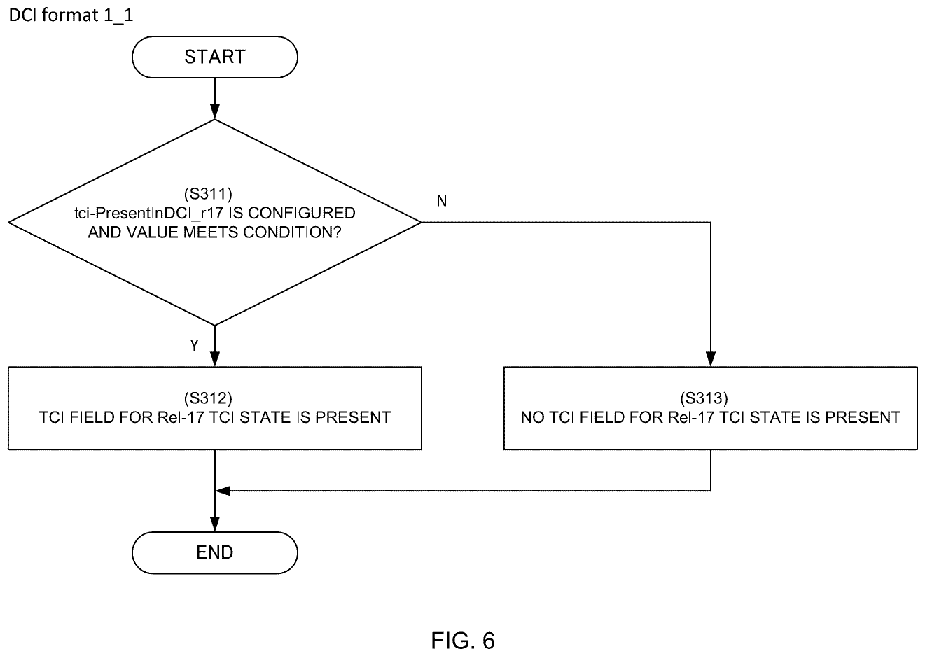

FIG. 6 shows, in a variation of Aspect 1-2, an example of a method of determining whether a TCI field in DCI format 1_1 is present. In S311, a UE judges whether tci-PresentInDCI_r17 is configured and the configured value meets a condition. Such a condition may be a condition that the value of tci-PresentInDCI_r17 is larger than 0 or may be a condition that the value of tci-PresentInDCI_r17 is 3 or smaller. If tci-PresentInDCI_r17 is configured and the value meets the condition (S311: Y), in S312, the UE judges that a TCI field for a Rel-17 TCI state is present. Such a TCI field may have a size of 3 bits or may have a size based on the value of tci-PresentInDCI_r17. Otherwise (S311: N), in S313, the UE judges that no TCI field for a Rel-17 TCI state is present.

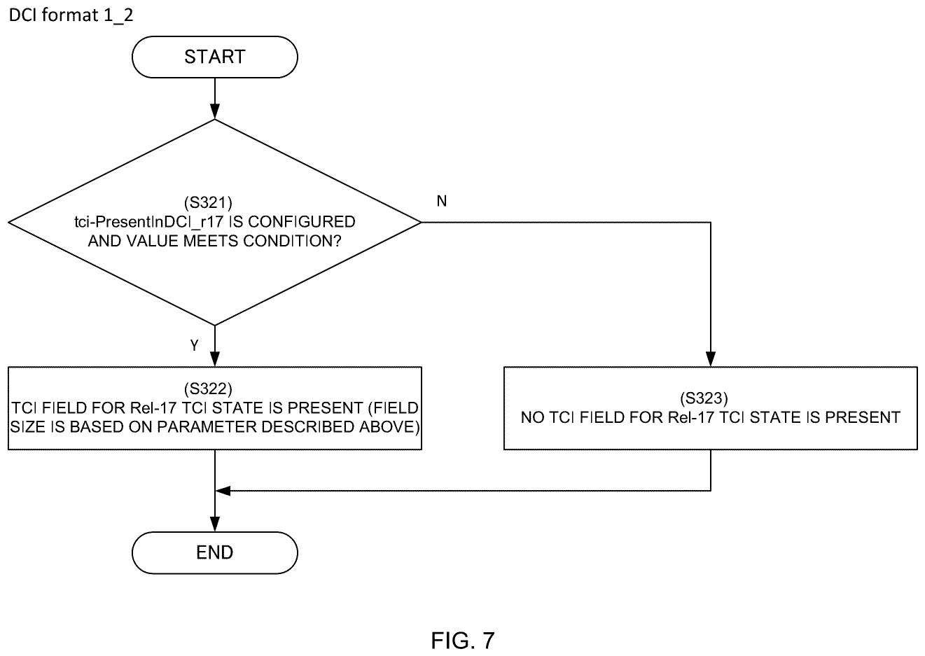

FIG. 7 shows, in a variation of Aspect 1-2, an example of a method of determining whether a TCI field in DCI format 1_2 is present. In S321, a UE judges whether tci-PresentInDCI_r17 is configured and the value meets a condition. If tci-PresentInDCI r17 is configured and the value meets the condition (S321: Y), in S322, the UE judges that a TCI field for a Rel-17 TCI state is present. Such a TCI field may have a size based on the value of tci-PresentInDCI_r17. Otherwise (S321: N), in S323, the UE judges that no TCI field for a Rel-17 TCI state is present.

### <<Aspect 1-3>>

A TCI field may be configured by a parameter per CORESET and the TCI filed may have a size depending on the value of the parameter.

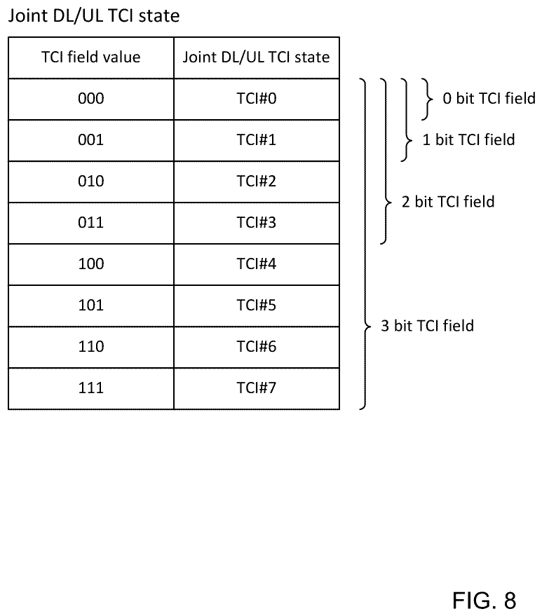

FIG. 8 shows an example of joint DL/UL TCI state indication. With respect to a TCI field value for joint DL/UL TCI state indication, a TCI state ID indicating a joint DL/UL TCI state is associated.

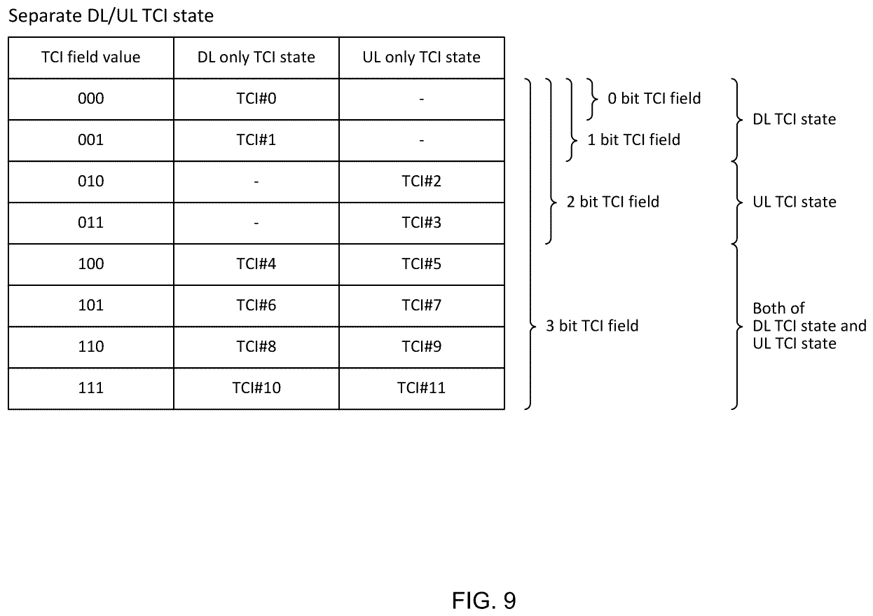

FIG. 9 shows an example of separate DL/UL TCI state indication. With respect to a TCI field value for separate DL/UL TCI state indication, at least one TCI state ID of a TCI state ID indicating a DL only TCI state and a TCI state ID indicating a UL only TCI state is associated. In this example, TCI field values 000 to 001 are each associated only with one TCI state ID for DL. TCI field values 010 to 011 are each associated only with one TCI state ID for UL. TCI field values 100 to 111 are each associated with both one TCI state ID for DL and one TCI state ID for UL.

In FIGS. 8 and 9, a UE may assume that a TCI field in DCI #1 corresponding to CORESET #1 configured with a 3-bit TCI field indicates a value (code point) in the range from 000 to 111. The UE may assume that a TCI field in DCI #2 corresponding to CORESET #2 configured with a 2-bit TCI field indicates a value (codepoint) in the range from 000 to 011. The UE may assume that a TCI field in DCI #3 corresponding to CORESET #3 configured with a 1-bit TCI field indicates a value (codepoint) in the range from 000 to 001. The UE may assume that a TCI field in DCI #4 corresponding to CORESET #4 configured with a 0-bit TCI field indicates a value (codepoint) of 000.

This embodiment allows a TCI state indication mode to be appropriately configured/indicated.

### Second Embodiment

This embodiment relates to a condition of presence of a TCI field for a Rel-17 TCI state.

### <<Aspect 2-1>>

For a Rel-17 TCI state (at least one of joint DL/UL TCI, DL only TCI, and UL only TCI), a UE may assume that no TCI field is present when Condition 1 is met.

Such a condition may include at least one condition of Condition 1-1 to Condition 1-4 below, may include the OR operation of at least two conditions of Condition 1-1 to Condition 1-4 below, or may include the AND operation of at least two conditions of Condition 1-1 to Condition 1-4 below.

### {Condition 1-1}

An RRC parameter in the first embodiment indicates that no TCI field for a Rel-17 TCI state is present.

### {Condition 1-2}

The number of (Rel-17) TCI states configured by an RRC parameter is one. In this case, TCI state indication based on a MAC CE/DCI is not performed, and thus no TCI field is necessary.

### {Condition 1-3}

The number of (Rel-17) TCI states activated by a MAC CE is one. In this case, TCI state indication based on DCI is not performed, and thus no TCI field is necessary. Note that, in order to prevent complication for blind detection of DCI in a UE, a DCI size may not need to be determined/changed depending on indication of the MAC CE.

### {Condition 1-4}

A UE reports that the UE supports only MAC CE based TCI state indication (the UE does not support DCI based TCI state indication).

### <<Aspect 2-2>>

For a Rel-17 TCI state (at least one of joint DL/UL TCI, DL only TCI, and UL only TCI), a UE may assume that a TCI field is present when Condition 2 is met.

Such a condition may include at least one condition of Condition 2-1 to Condition 2-4 below, may include the OR operation of at least two conditions of Condition 2-1 to Condition 2-4 below, or may include the AND operation of at least two conditions of Condition 2-1 to Condition 2-4 below.

### {Condition 2-1}

An RRC parameter in the first embodiment indicates that a TCI field for a Rel-17 TCI state is present.

### {Condition 2-2}

The number of (Rel-17) TCI states configured by an RRC parameter is greater than one. In this case, if only one TCI state is activated by a MAC CE, no TCI field is necessary.

### {Condition 2-3}

The number of (Rel-17) TCI states activated by a MAC CE is greater than one. In this case, TCI state indication based on DCI is performed, and thus a TCI field is necessary. Note that, in order to prevent complication for blind detection of DCI in a UE, a DCI size may not need to be determined/changed depending on indication of the MAC CE.

### {Condition 2-4}

A UE reports that the UE supports DCI based TCI state indication.

This embodiment allows a UE to appropriately determine whether a TCI field is present.

### Third Embodiment

This embodiment relates to a method of configuring/indicating at least one of Mode 1 to Mode 3 below.
{Mode 1}MAC CE based TCI state indication
{Mode 2}DCI based TCI state indication by DCI format 1_1/1_2 with DL assignment
{Mode 3}DCI based TCI state indication by DCI format 1_1/1_2 without DL assignment

A UE having reported, by a UE capability, that the UE supports one or more modes out of Mode 1 to Mode 3 may follows either Operation 1 or Operation 2 below.

### {Operation 1}

All of the one or more modes reported may be configured/indicated.

### {Operation 2}

Out of the one or more modes reported, a mode(s) based on configuration/indication by an RRC parameter/MAC CE may be indicated. For example, a mode may be configured/indicated by an RRC parameter/MAC CE. For example, with Mode 2, Mode 3, or Mode 2 and Mode 3 being configured/indicated by an RRC parameter/MAC CE, by which DCI a TCI state is to be indicated may be configured/indicated. In a case where Mode 3 is not configured, with use of the value of the special field described above, operation of distinguishing DCI is not necessary, allowing processing in a UE to be simplified (allowing a price/power consumption of the UE to be suppressed). For example, in a case where the number of active TCI states indicated by a MAC CE is one (for a given BWP/CC), only Mode 1 may be configured. As described above, a mode may be configured/indicated implicitly, or a combination of modes may be indicated by an explicit higher layer parameter.

This embodiment allows a TCI state indication mode to be appropriately configured/indicated.

### Other Embodiments

### <<UE Capability Information/Higher Layer Parameter>>

A higher layer parameter (RRC IE)/UE capability corresponding to a function (characteristics, feature) in the embodiments described above may be defined. The higher layer parameter may indicate whether to enable the function. The UE capability may indicate whether a UE supports the function.

The UE configured with the higher layer parameter corresponding to the function may perform the function. “The UE not configured with the higher layer parameter corresponding to the function does not perform the function (for example, the UE conforms to Rel. 15/16)” may be defined.

The UE that has reported/transmitted the UE capability indicating support of the function may perform the function. “The UE that has not reported the UE capability indicating support of the function does not perform the function (for example, the UE conforms to Rel. 15/16)” may be defined.

When the UE reports/transmits the UE capability indicating support of the function and is configured with the higher layer parameter corresponding to the function, the UE may perform the function. “When the UE does not report/transmit the UE capability indicating support of the function or when the UE is not configured with the higher layer parameter corresponding to the function, the UE does not perform the function (for example, the UE conforms to Rel. 15/16)” may be defined.

Which embodiment/option/choice/function out of the plurality of embodiments described above is to be used may be configured by a higher layer parameter, may be reported by a UE as a UE capability, may be defined in a specification, or may be determined by means of a UE capability reported and configuration of a higher layer parameter.

The UE capability may indicate whether the UE supports at least one function of the following.
Basic function of a unified TCI state for joint TCI indication This may include TCI indication for updating and activation or may include a TCI state indication mode (in a case of updating). The TCI state indication mode may include MAC CE based TCI state indication for one active TCI state.
Additional function of a unified TCI state for joint TCI indication This may include a TCI state indication mode. The TCI state indication mode may include MAC CE+DCI based TCI state indication (use of DCI format 1_1/1_2 with DL assignment) or may include MAC CE+DCI based TCI state indication (use of DCI format 1_1/1_2 without DL assignment).
Basic function of a unified TCI state for separate TCI indication This may include TCI indication for updating and activation or may include a TCI state indication mode (in a case of updating). The TCI state indication mode may include MAC CE based TCI state indication for one active TCI state.
Additional function of a unified TCI state for separate TCI indication This may include a TCI state indication mode. The TCI state indication mode may include MAC CE+DCI based TCI state indication (use of DCI format 1_1/1_2 with DL assignment) or may include MAC CE+DCI based TCI state indication (use of DCI format 1_1/1_2 without DL assignment).

The DCI based TCI indication is an optional function, and thus not all UEs supporting a Rel-17 unified TCI state supports the function. For a UE not supporting the DCI based TCI indication, no TCI field need to be configured.

According to the UE capability/higher layer parameter described above, the UE can implement the functions described above while maintaining compatibility with an existing specification.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

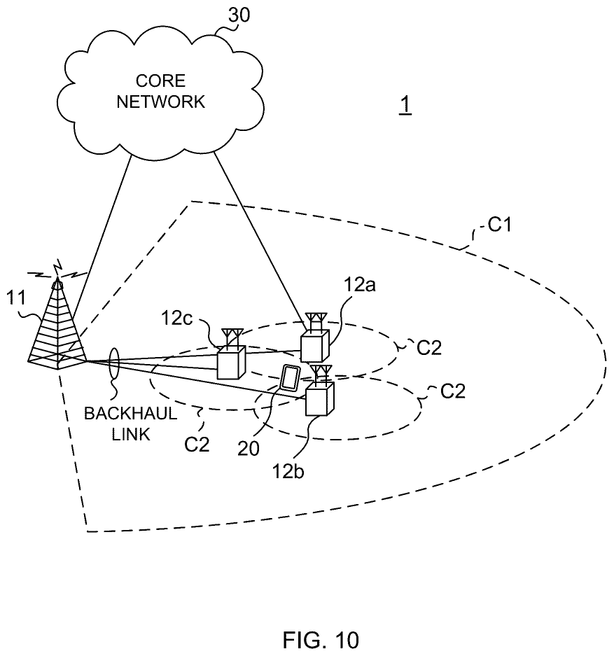

FIG. 10 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a reference signal for measurement (Sounding Reference Signal (SRS)), a demodulation reference signal (DMRS), and so on may be communicated as an uplink reference signal (UL-RS). Note that DMRS may be referred to as a “user terminal specific reference signal (UE-specific Reference Signal).”

### (Base Station)

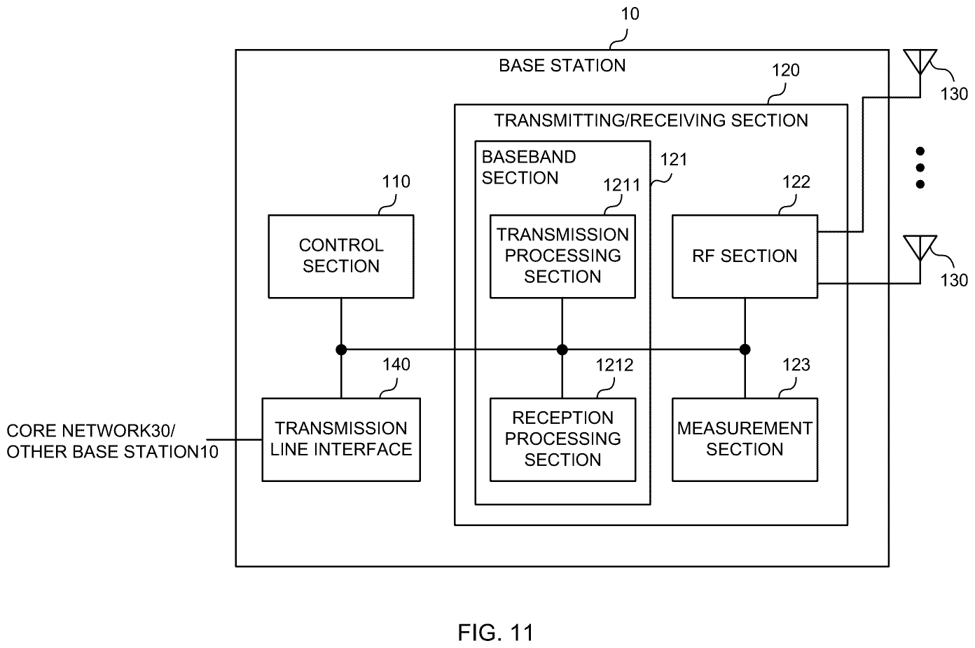

FIG. 11 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, demapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a list indicating transmission configuration indication (TCI) states applicable to a plurality of types of signals and a configuration related to a field in downlink control information for indication of one or more TCI states in the list. The control section 110 may determine a size of the field on the basis of at least one of the list, the configuration, and capability information related to the indication.

### (User Terminal)

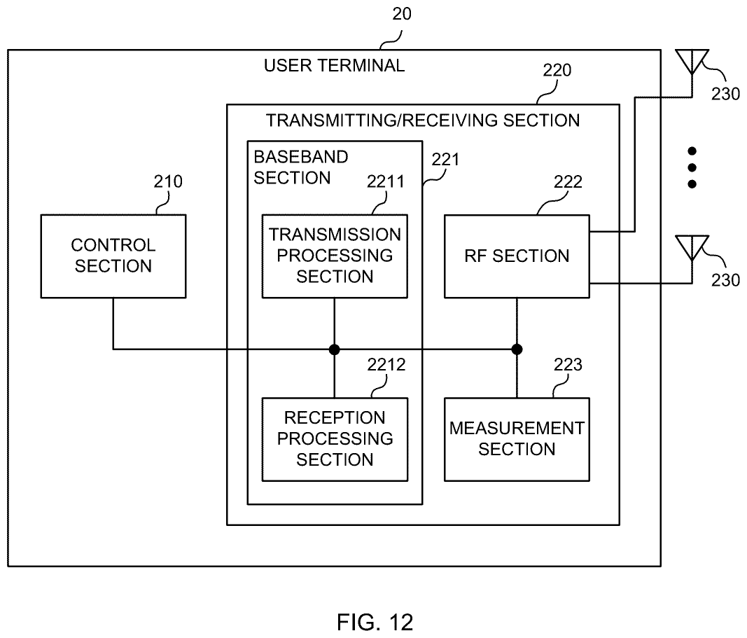

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, demapping, demodulation, decoding (which may include error correction decoding), MAC layer processing, the processing of the RLC layer and the processing of the PDCP layer, and so on, on the acquired baseband signal, and acquire user data and the like.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a list indicating transmission configuration indication (TCI) states applicable to a plurality of types of signals and a configuration related to a field in downlink control information for indication of one or more TCI states in the list. The control section 210 may determine a size of the field on the basis of at least one of the list, the configuration, and capability information related to the indication.

The configuration may indicate presence of either the field only for the one or more TCI states or the field for the one or more TCI state and for a TCI state applicable only to one type of signal.

The control section 210 may determine the size of the field on the basis of the number of TCI states in the list.

The control section 210 may report the capability information indicating support of one or more functions out of indicating the one or more TCI states by a medium access control (MAC) control element (CE), indicating the one or more TCI states by the downlink control information with downlink assignment, and indicating the one or more TCI states by the downlink control information without downlink assignment. The configuration may configure a part or all of the one or more functions.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

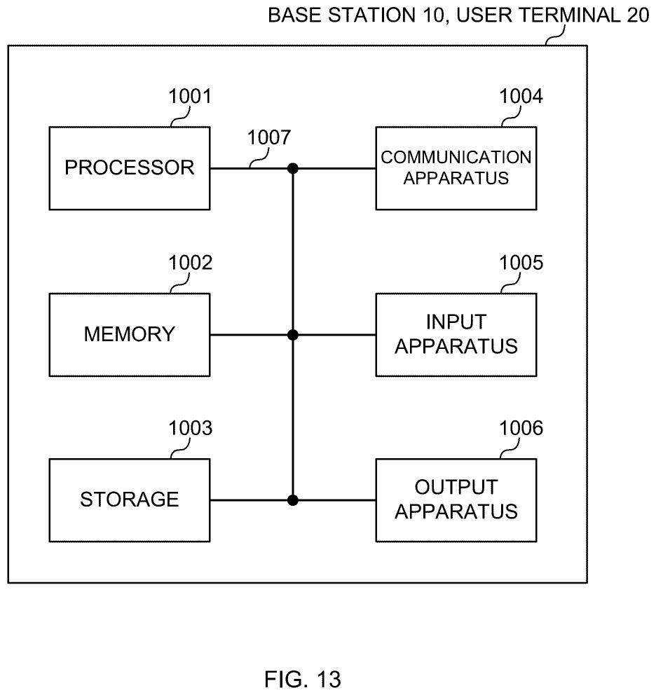

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Modification Examples

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filtering processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CEs).

Also, notification of given information (for example, notification of “being X”) does not necessarily have to be notified explicitly, and can be notified implicitly (by, for example, not notifying this given information or notifying another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms such as “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

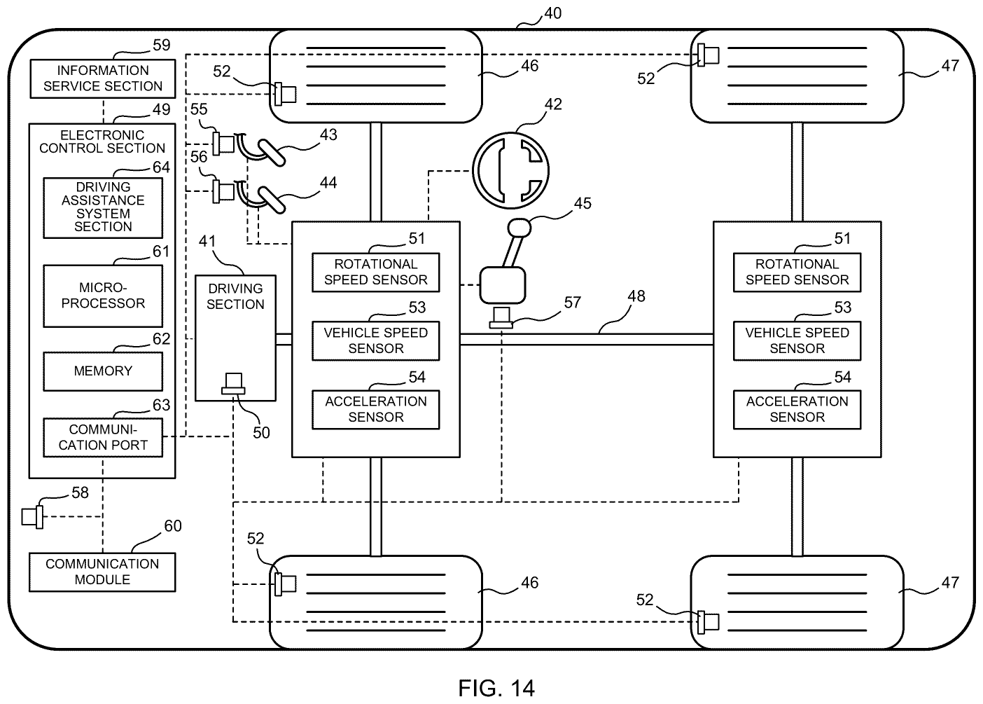

FIG. 14 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of operations. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some operations.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

The present application is based on Japanese Patent Application No. 2022-026886 filed on Feb. 24, 2022, the entire contents of which are incorporated herein by reference.

1. A terminal comprising:
a receiving section that receives a list indicating transmission configuration indication (TCI) states applicable to a plurality of types of signals and a configuration related to a field in downlink control information for indication of one or more TCI states in the list; and
a control section that determines a size of the field on the basis of at least one of the list, the configuration, and capability information related to the indication.

2. The terminal according to claim 1, wherein the configuration indicates presence of either the field only for the one or more TCI states or the field for the one or more TCI states and for a TCI state applicable only to one type of signal.

3. The terminal according to claim 1, wherein the control section determines the size of the field on the basis of the number of TCI states in the list.

4. The terminal according to claim 1, wherein
the control section reports the capability information indicating support of one or more functions out of indicating the one or more TCI states by a medium access control (MAC) control element (CE), indicating the one or more TCI states by the downlink control information with downlink assignment, and indicating the one or more TCI states by the downlink control information without downlink assignment, and
the configuration configures a part or all of the one or more functions.

5. A radio communication method for a terminal, the radio communication method comprising:
receiving a list indicating transmission configuration indication (TCI) states applicable to a plurality of types of signals and a configuration related to a field in downlink control information for indication of one or more TCI states in the list; and
determining a size of the field on the basis of at least one of the list, the configuration, and capability information related to the indication.

6. A base station comprising:
a transmitting section that transmits a list indicating transmission configuration indication (TCI) states applicable to a plurality of types of signals and a configuration related to a field in downlink control information for indication of one or more TCI states in the list; and
a control section that determines a size of the field on the basis of at least one of the list, the configuration, and capability information related to the indication.

7. The terminal according to claim 2, wherein
the control section reports the capability information indicating support of one or more functions out of indicating the one or more TCI states by a medium access control (MAC) control element (CE), indicating the one or more TCI states by the downlink control information with downlink assignment, and indicating the one or more TCI states by the downlink control information without downlink assignment, and
the configuration configures a part or all of the one or more functions.

8. The terminal according to claim 3, wherein
the control section reports the capability information indicating support of one or more functions out of indicating the one or more TCI states by a medium access control (MAC) control element (CE), indicating the one or more TCI states by the downlink control information with downlink assignment, and indicating the one or more TCI states by the downlink control information without downlink assignment, and
the configuration configures a part or all of the one or more functions.
